(19) United States
(12) Patent Application Publication
(10) Pub. No.: US 2024/0250424 A1
(43) Pub. Date: Jul. 25, 2024

(54) MULTI-CHIP MULTI-CHANNEL BEAMFORMER MODULE WITH INTERPOSER PASSIVES

(71) Applicant: SKYWORKS SOLUTIONS, INC., Irvine, CA (US)

(72) Inventors: Siva Viswanathan THYAGARAJAN, San Jose, CA (US); Stephen Joseph KOVACIC, Newport Beach, CA (US)

(21) Appl. No.: 18/521,973

(22) Filed: Nov. 28, 2023

Related U.S. Application Data
(60) Provisional application No. 63/428,394, filed on Nov. 28, 2022.

(51) Int. Cl. H01Q 3/36; H01L 25/10

(52) U.S. Cl. CPC H01Q 3/36; H01L 25/105

(57) ABSTRACT

In some embodiments, a packaged module can include a packaging substrate having a plurality of interposer layers, and an array of transmit and/or receive elements implemented on a respective interposer layer, each transmit/receive element partitioned into a first block configured to provide high-performance functionality, and a second block configured to provide digitally-intensive low-performance functionality, the first and second blocks in combination configured to provide multi-channel beamforming functionality.

### CROSS-REFERENCE TO RELATED APPLICATION(S)

This application claims priority to U.S. Provisional Application No. 63/428,394 filed Nov. 28, 2022, entitled MULTI-CHIP MULTI-CHANNEL BEAMFORMER MODULE WITH INTERPOSER PASSIVES, the disclosure of which is hereby expressly incorporated by reference herein in its respective entirety.

### BACKGROUND

### Field

The present disclosure relates to beamformer modules with interposer passive elements.

### Description of the Related Art

A phased array includes an array of antennas that utilizes beamforming technology to steer transmit or receive electromagnetic beams. Such antennas are driven by radio-frequency (RF) signals that follow an amplitude and phase relationship. By linearly phasing the RF signal across the antenna array, the resulting electromagnetic beam in a transmit array can be steered electronically in a desired direction.

### SUMMARY

In accordance with some implementations, the present disclosure relates to a packaged module that includes a packaging substrate having a plurality of interposer layers, and an array of receive elements implemented on a respective interposer layer. Each receive element is partitioned into a first block configured to provide high-performance functionality, and a second block configured to provide digitally-intensive low-performance functionality. The first and second blocks in combination are configured to provide multi-channel beamforming functionality.

In some embodiments, the first and second blocks in combination can be implemented in a multi-chip configuration.

In some embodiments, the first block can be implemented to occupy a relatively small area on a die formed from a high-cost process technology node. In some embodiments, the die can include a SiGe die, an SOI die or a GaAs die. In some embodiments, the first block can include a front-end module. In some embodiments, the first block can include at least a portion of a low-noise amplifier. In some embodiments, the first block can include only one stage of the low-noise amplifier, such as an input stage of the low-noise amplifier.

In some embodiments, the second block can be implemented to occupy a relatively large area on a die formed from a low-cost process technology node. In some embodiments, the low-cost process die can include a CMOS die. In some embodiments, the second block can include a beamformer die. In some embodiments, the second block can include a low-performance component such as a portion of a low-noise amplifier. Such a portion of the low-noise amplifier of the low-performance component can include an output stage. The low-performance component can include a phase shifter. The low-performance component can include a variable gain amplifier stage. The low-performance component can include a temperature sensor. The low-performance component can include a bias circuit.

In some embodiments, the second block can include a digitally-intensive component. The digitally-intensive component can include one or more of a control circuit, a memory circuit, and a lookup table.

In some embodiments, the packaged module can further include passive devices implemented on a respective interposer layer and configured to function with either or both of the first and second blocks. In some embodiments, the interposer layer with the passive devices can be the same interposer layer with the array of receive elements.

In some embodiments, the interposer layer with the passive devices can be formed from a low loss material. Each passive device can have a quality factor value Q that is greater than a quality factor value achievable on a die associated with the first or second block.

In some embodiments, the passive devices can include an inductor or transformer configured to provide matching functionality. In some embodiments, the inductor or transformer can be printed directly on the interposer layer. The printed inductor or transformer can include a sufficiently thick metal trace to provide a desired quality factor value Q. In some embodiments, the inductor or transformer can be implemented as a surface mounted component configured for lower frequency operation.

In some embodiments, each of the first and second blocks can include measurement and control blocks configured to provide a bidirectional communication between the first and second blocks to provide improved calibration, tracking and/or performance.

In some embodiments, the second block can include one or more electrostatic discharge circuits.

In some implementations, the present disclosure relates to a packaged module that includes a packaging substrate having a plurality of interposer layers and an array of transmit elements implemented on a respective interposer layer. Each transmit element is partitioned into a first block configured to provide high-performance functionality, and a second block configured to provide digitally-intensive low-performance functionality. The first and second blocks in combination are configured to provide multi-channel beamforming functionality.

In some embodiments, the first and second blocks in combination can be implemented in a multi-chip configuration.

In some embodiments, the first block can be implemented to occupy a relatively small area on a die formed from a high-cost process technology node. In some embodiments, the die can include a SiGe die, an SOI die or a GaAs die.

In some embodiments, the first block can include a front-end module.

In some embodiments, the first block can include at least a portion of a power amplifier. In some embodiments, the first block can include only one stage of the power amplifier. The only one stage of the power amplifier can be an output stage of the power amplifier.

In some embodiments, the second block can be implemented to occupy a relatively large area on a die formed from a low-cost process technology node. In some embodiments, the low-cost process die can include a CMOS die.

In some embodiments, the second block can include a beamformer die.

In some embodiments, the second block can include a low-performance component. In some embodiments, the low-performance component can include a portion of a power amplifier. The portion of the power amplifier of the low-performance component can include an input stage.

In some embodiments, the low-performance component can include a phase shifter. In some embodiments, the low-performance component can include a variable gain amplifier stage. In some embodiments, the low-performance component can include a temperature sensor and/or a power detector. In some embodiments, the low-performance component can include a bias circuit.

In some embodiments, the second block can include a digitally-intensive component such as one or more of a control circuit, a memory circuit, and a lookup table.

In some embodiments, the packaged module can further include passive devices implemented on a respective interposer layer and configured to function with either or both of the first and second blocks. In some embodiments, the interposer layer with the passive devices can be the same interposer layer with the array of receive elements.

In some embodiments, the interposer layer with the passive devices can be formed from a low loss material. In some embodiments, each passive device can have a quality factor value Q that is greater than a quality factor value achievable on a die associated with the first or second block.

In some embodiments, the passive devices can include an inductor or transformer configured to provide matching functionality. In some embodiments, the inductor or transformer can be printed directly on the interposer layer. The printed inductor or transformer can include a sufficiently thick metal trace to provide a desired quality factor value Q.

In some embodiments, the inductor or transformer can be implemented as a surface mounted component configured for lower frequency operation.

In some embodiments, each of the first and second blocks can include measurement and control blocks configured to provide a bidirectional communication between the first and second blocks to provide improved calibration, tracking and/or performance.

In some embodiments, the second block can include one or more electrostatic discharge circuits.

In some implementations, the present disclosure relates to a packaged module that includes a packaging substrate having a plurality of interposer layers, and an array of transceiver elements implemented on a respective interposer layer. Each transceiver element is partitioned into a first block configured to provide high-performance functionality, and a second block configured to provide digitally-intensive low-performance functionality. The first and second blocks in combination are configured to provide multi-channel beamforming functionality.

In some embodiments, the first and second blocks in combination can be implemented in a multi-chip configuration.

In some embodiments, the first block can be implemented to occupy a relatively small area on a die formed from a high-cost process technology node. In some embodiments, such a die can include a SiGe die, an SOI die or a GaAs die.

In some embodiments, the first block can include a front-end module.

In some embodiments, the first block can include at least a portion of a power amplifier and/or at least a portion of a low-noise amplifier. In some embodiments, the first block can include only one stage of the power amplifier, such as an output stage of the power amplifier. In some embodiments, the first block can include only one stage of the low-noise amplifier, such as an input stage of the low-noise amplifier.

In some embodiments, the second block can be implemented to occupy a relatively large area on a die formed from a low-cost process technology node. In some embodiments, the low-cost process die can include a CMOS die.

In some embodiments, the second block can include a beamformer die.

In some embodiments, the second block can include a low-performance component such as a portion of a power amplifier including an input stage. In some embodiments, the low-performance component can include a portion of a low-noise amplifier such as an output stage.

In some embodiments, the low-performance component can include some or all of a phase shifter, a variable gain amplifier stage, a temperature sensor and/or a power detector, a bias circuit and a digitally-intensive component such as a control circuit, a memory circuit, and a lookup table.

In some embodiments, the packaged module can further include passive devices implemented on a respective interposer layer and configured to function with either or both of the first and second blocks. In some embodiments, the interposer layer with the passive devices can be the same interposer layer with the array of transceiver elements.

In some embodiments, the interposer layer with the passive devices can be formed from a low loss material. In some embodiments, each passive device can have a quality factor value Q that is greater than a quality factor value achievable on a die associated with the first or second block.

In some embodiments, the passive devices can include an inductor or transformer configured to provide matching functionality. In some embodiments, the inductor or transformer can be printed directly on the interposer layer. The printed inductor or transformer can include a sufficiently thick metal trace to provide a desired quality factor value Q.

In some embodiments, the inductor or transformer can be implemented as a surface mounted component configured for lower frequency operation.

In some embodiments, each of the first and second blocks can include measurement and control blocks configured to provide a bidirectional communication between the first and second blocks to provide improved calibration, tracking and/or performance.

In some embodiments, the second block can include one or more electrostatic discharge circuits.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts an integrated phased array beamforming receiver that utilizes a radio-frequency (RF) beamforming architecture.

FIG. 2 shows an example of design partitioning that can be implemented for a phased array beamforming receiver.

FIG. 3 shows an example of noise figure variation of an example Ka band (17.8-21.2 GHZ) receiver with a change in quality factor of inductors.

FIG. 4 shows an example of a front-end receiver circuit that includes multiple chips and high-quality factor inductors and other passives implemented on an interposer.

FIG. 5 depicts an example of a multi-chip module phased array beamforming receiver with high quality factor inductors and other passives implemented on an interposer.

FIG. 6 shows an example of a communication functionality (e.g., bidirectional data/control bus) between a front-end module and a beamformer in a multi-chip module phased array beamforming receiver.

FIG. 7 shows an example of an electrostatic discharge (ESD) block sharing between a front-end module and a beamformer in a multi-chip module phased array beamforming receiver.

FIG. 8 shows an example of a multi-chip module phased array beamforming transmitter that can enhance RF performance at a relatively lower cost using one or more features of design partitioning as described herein.

FIG. 9 shows an example of a multi-chip module phased array beamforming transceiver that can enhance RF performance at a relatively lower cost using one or more features of design partitioning as described herein.

FIG. 10 shows that in some embodiments, a wireless platform can include a multi-chip beamforming module having one or more features as described herein.

### DETAILED DESCRIPTION OF SOME EMBODIMENTS

The headings provided herein, if any, are for convenience only and do not necessarily affect the scope or meaning of the claimed invention.

The present disclosure relates generally to wireless communication circuits, devices, systems and methods, and more particularly, to high performance low-cost beamformer modules for phased array applications.

A phased array includes an array of antennas that utilizes beamforming technology to steer transmit or receive electromagnetic beams. Such antennas can be driven by radio-frequency (RF) signals that follow an amplitude and phase relationship. For example, by linearly phasing an RF signal across a transmit antenna array, the resulting electromagnetic beam can be steered electronically in a desired direction.

As an array is utilized, the equivalent isotropic radiated power (EIRP) is also significantly increased. A similar benefit is also seen on a receiver end due to enhanced sensitivity. By adjusting the amplitude of a signal across the array, an antenna pattern can be controlled electronically for beam nulling and/or interference cancellation.

Phased array systems can be classified broadly into two types—namely passive and active arrays. In a passive array, RF signals from antenna elements are distributed after phase shifting to a single receiver, and vice versa for a transmitter. Hence, there is typically a single receiver or transmitter for the whole array. In an active array, each antenna element has its own receiver or transmitter along with a phase shifter and variable gain amplifier. In some applications, active antenna arrays are more popular due to their better performance, functionality, and flexibility.

In many communication applications, phased arrays are becoming desirable for 5G applications at both sub-6 GHZ and millimeter wave frequencies. A phased array operating at millimeter wave frequencies can include many thousand antenna elements, whereas those operating at lower frequencies can include hundreds of antenna elements. Using an active array antenna technology for these applications would require many chips and therefore an overall solution can become cost prohibitive.

Cost of a phased array system can be lowered by implementing the system in a low-cost technology node. However, in such a system, performance (e.g., in terms of transmitter efficiency and receiver sensitivity) and functionality are typically degraded.

Thus, a beamformer chip or multi-chip module solution that provides high performance and functionality without high cost would be desirable.

In some implementations, an apparatus can include an array of receive elements. Each receive element can be partitioned into a high-performance block and a high functionality digitally intensive low performance block. For example, a high-performance block can include a low noise amplifier and can be implemented in a high performance higher-cost process with a relatively small die area. Associated with such a high-performance block, a high functionality digitally intensive low performance block can include, for example, amplifiers, phase shifters, variable gain stages, look up tables, etc., and can be implemented in a low-cost process with a relatively larger die area. In some embodiments, both die can be combined on an interposer with high quality passive devices (e.g., printed or surface mounted components) to provide a multi-channel multi-chip high-performance beamformer module.

Similarly, an apparatus can include an array of transmit elements. Each transmit element can be partitioned into a high-performance block and a high functionality digitally intensive low performance block. For example, a high-performance block can include a power amplifier and can be implemented in a high performance higher-cost process with a relatively small die area. Associated with such a high-performance block, a high functionality digitally intensive low performance block can include, for example, amplifiers, phase shifters, variable gain stages, look up tables, etc., and can be implemented in a low-cost process with a relatively larger die area. In some embodiments, both die can be combined on an interposer with high quality passive devices (e.g., printed or surface mounted components) to provide a multi-channel multi-chip high-performance beamformer module.

Described herein are examples of design features that can be implemented for various blocks of a transmitter or a receiver. For example, performance and cost metrics of various blocks can be considered for a transmitter or a receiver.

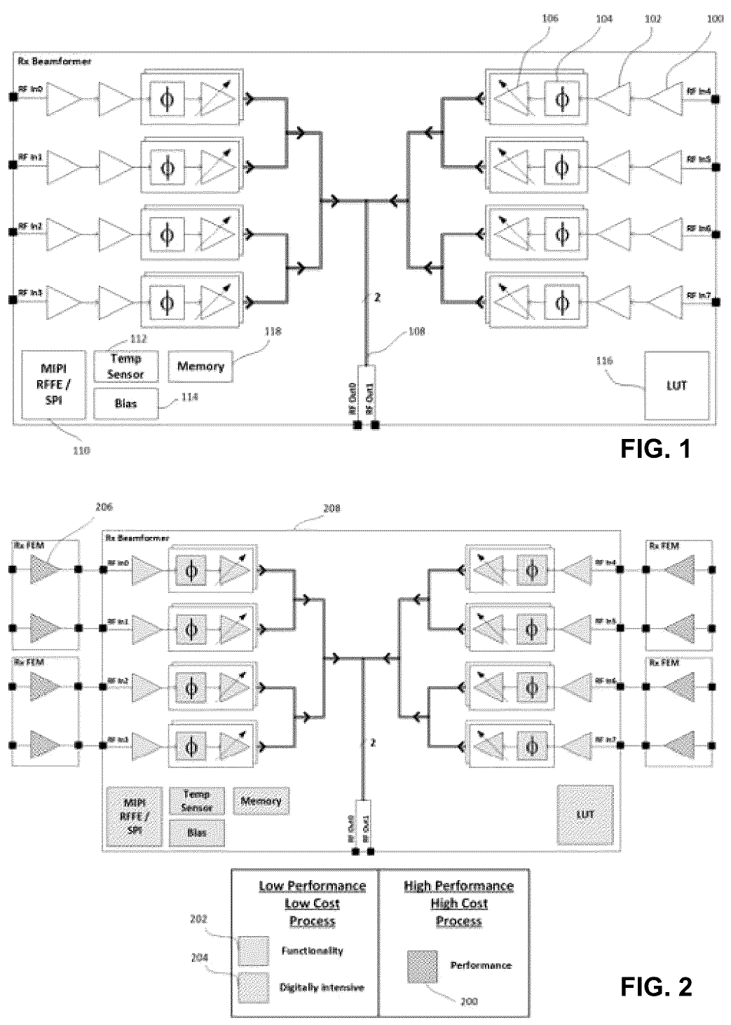

An example of a typical phased array receiver beamformer employing radio-frequency (RF) beamforming is shown in FIG. 1. Such a beamformer is shown to include eight example channels and support two user streams. Each RF channel is shown to include a respective low-noise amplifier (LNA) having two stages 100, 102, with the stage 100 receiving a respective input RF signal.

In FIG. 1, the LNA-amplified input RF signal is shown to be split across two streams and is then processed by a phase shifter 104 and a variable gain amplifier stage 106. The processed RF signals from eight of such channels are shown to be combined using a passive combiner network (e.g., Wilkinson, transformer based, etc.) 108 to form an output.

The foregoing beamformer can be controlled using, for example, a MIPI RFFE/SPI interface 110 and can include additional blocks such as a temperature sensor 112, a bias circuit 114, etc. To store beam directions, a look up table (LUT) 116 can be utilized along with memory blocks 118 to store factory calibration settings.

The beamformer of FIG. 1 is typically implemented as a monolithic fully integrated circuit in a high-performance process. Due to a large area occupied by such design, the overall solution tends to be costly.

In order to reduce cost, some designs compromise performance by implementing a solution in a relatively low-cost technology (e.g., a silicon-on-insulator (SOI) process as a compromise between a CMOS (low-cost, low performance) process and a SiGe (high-cost, high performance) process. The performance of these solutions, especially at millimeter wave frequencies, is typically dictated mainly by quality factors (Q) of passive devices which are usually low for silicon-based processes (e.g., Q of 18 at Rx Ka band frequency of 20 GHZ).

It is noted that passive devices are important at RF (e.g., millimeter wave) frequencies for matching purposes to achieve maximum or improved performance. For example, an insertion loss (IL) for a matching network circuit is given as IL (dB)=10 log₁₀(1+Q/Q_c), where Q is the loaded quality factor of the matching network and Q_c the passive component quality factor. Therefore, having a higher passive component quality factor would result in a lower insertion loss.

The insertion loss also translates directly to noise figure degradation (e.g., one to one for a matched system) and hence can play an important role in determining the performance of the overall system.

For a phased array receiver, another figure of merit that is typically used is G/T ratio, where G is the gain of a receive path and T the noise temperature of the receiver. It is desirable to have this ratio as high as possible for better receiver sensitivity. The G/T ratio can be increased by scaling up the array or by reducing the noise temperature or equivalently the noise figure of the receiver. For example, a 0.5 dB improvement in noise figure results in a 25% reduction in the array size for the same G/T ratio. Hence, every tenth of a dB of noise figure can be important. Therefore, it is desirable to utilize high quality passive devices for matching purposes to improve the overall G/T of a solution.

FIG. 2 shows that in some embodiments, a receiver design can be implemented to simultaneously provide cost reduction and performance improvement. In the example of FIG. 2, various blocks can include three groups based on performance (e.g., high-performance block 200), functionality (e.g., functionality block 202), and digital intensiveness (e.g., digitally intensive block 204).

In some embodiments, the high-performance block 200 can include a selected low-noise amplifier (LNA) stage 206 (e.g., a single input stage) that is implemented in a high performance high-cost process. As only a few blocks are implemented in such a process, the associated cost is minimal or relatively low, but the performance is desirably high.

In some embodiments, the digitally intensive and functionality blocks (collectively indicated as 208) can be implemented in a low performance low-cost process. Even though such a design occupies a larger area, the impact of such an implementation on the overall cost of the receiver design is minimal or relatively low.

Accordingly, a design partition as provided above can allow achievement of a lower cost for the overall solution.

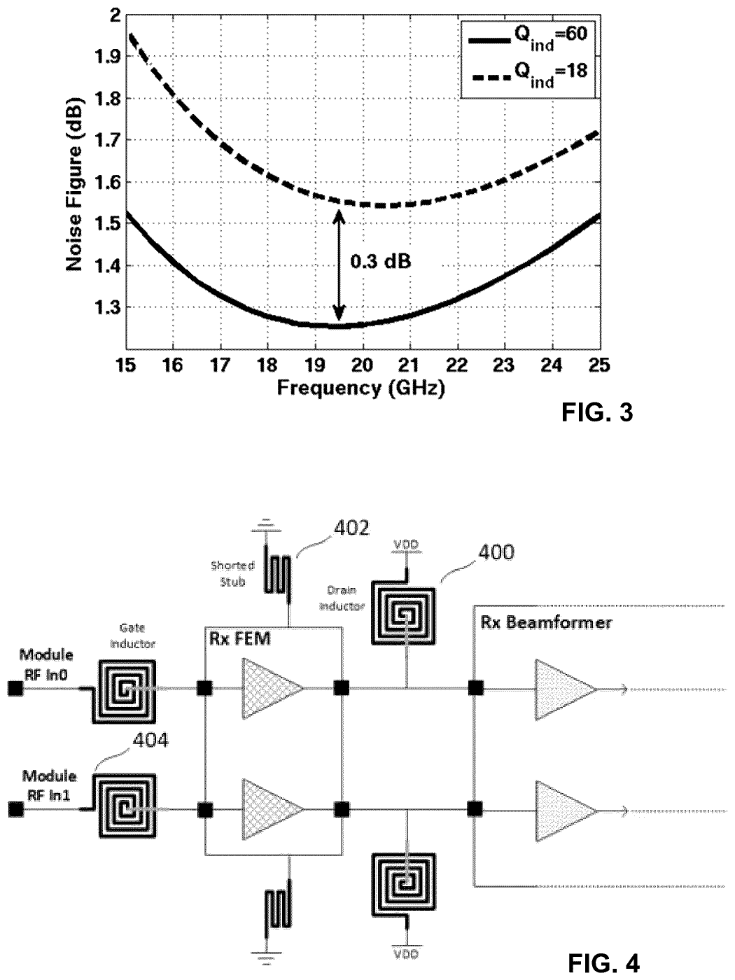

In the example of FIG. 2, a third component of partitioning configuration can include an implementation of passive devices for matching. FIG. 3 shows simulation results of a matched front-end LNA block for different passive component quality factors. More particularly, the dashed curve corresponds to a Q value of 18 for an inductor, and the solid curve corresponds to a Q value of 60 for the inductor. One can see that the noise figure of the LNA improves by 0.3 dB when the component quality factor is improved from 18 to 60.

FIG. 4 shows that in some embodiments, some or all of passive devices can be implemented on one or more interposers to achieve such high-quality factors. In the example of FIG. 4, two channels of a receiver are shown. More particularly, in some embodiments, drain, source and gate inductors (400, 402, 404, respectively) can be implemented directly on an interposer. In some embodiments, such inductors can be printed on the interposer, be provided as surface mounted (SMT) components (e.g., for lower frequencies), or some combination thereof. In some embodiments, some or all of the inductors 400, 402, 404 can achieve high quality factor with use of large trace thickness(es) and/or low loss of the interposer material.

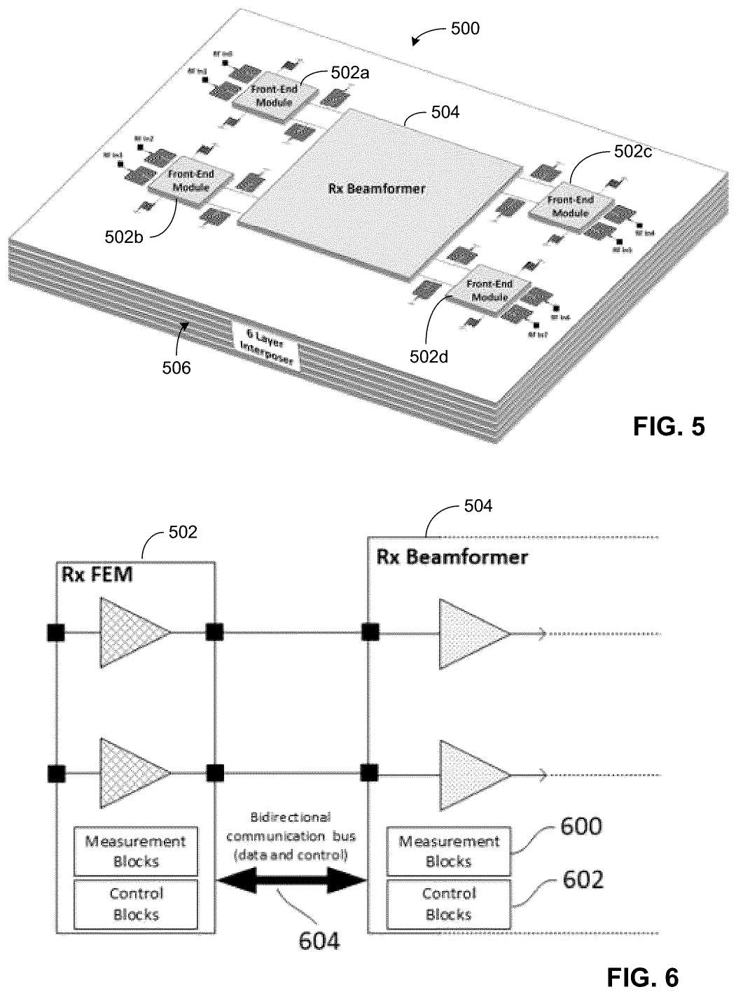

FIG. 5 shows a perspective view of an example of a packaged module implemented for the example architecture of FIGS. 2 and 4. In the example of FIG. 5, a packaged module 500 is shown to include an Rx beamformer chip 504 supporting eight channels, four two-channel front-end modules 502a, 502b, 502c, 502d and respective passive devices (e.g., high quality factor printed inductors) implemented on an interposer. In the example of FIG. 5, the packaged module 500 is shown to have six interposer layers 506; however, it will be understood that more or less numbers of interposer layers can also be utilized. It will also be understood that a packaged module having one or more features as described herein can also be implemented to provide Tx functionalities.

FIG. 6 shows that in some embodiments, design partitioning can include implementation of one or more measurement blocks 600 and/or one or more control blocks 602 for some or all of the chips in a module, such as the example of FIG. 5. For example, the Rx beamformer chip 504 can include measurement blocks 600 and control blocks 602. Similarly, each Rx front-end module 502 can include measurement blocks 600 and control blocks 602.

In the example of FIG. 6, the measurement blocks 600 can be configured to measure metrics such as input RF power on the front-end module 502 or output RF power or receive gain of the beamformer 504. These measurements can then be used to adjust circuit parameters such as gain codes, bias currents, etc. using the respective control blocks 602. To support such measurement and control functionalities, a bidirectional communication channel 604 can be provided between the chips (e.g., Rx front-end module 502 and Rx beamformer 504 chips). In some embodiments, both data and control information can be shared across the link 604. Such a communication functionality can allow various channels to work in coherence thereby improving the performance of the overall solution.

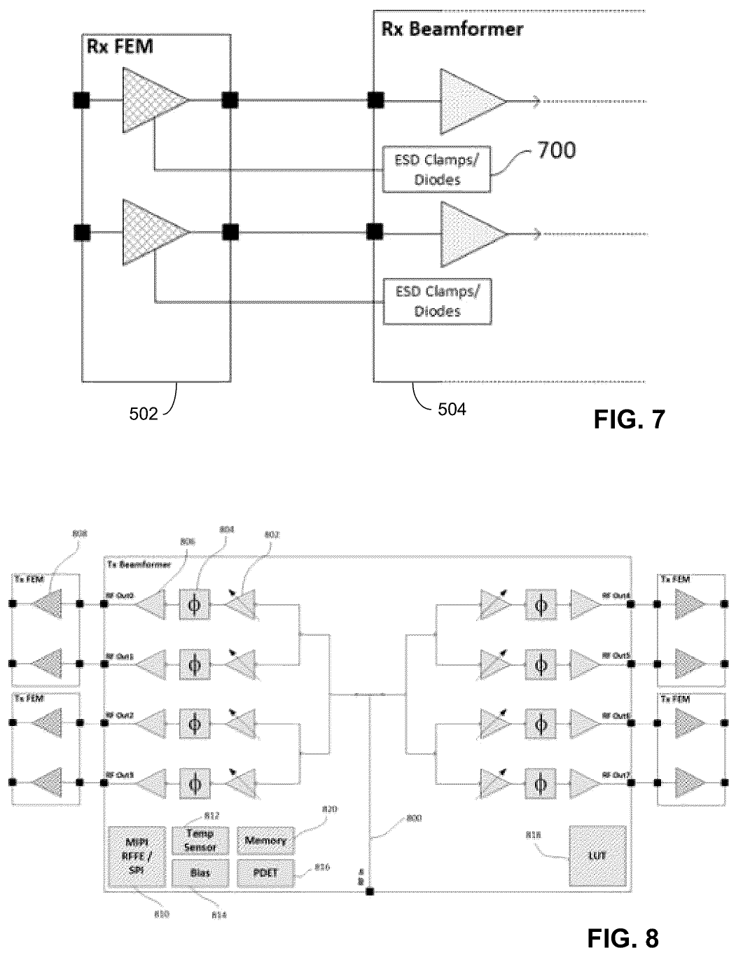

FIG. 7 shows that in some embodiments, the foregoing partitioning design can also include an electrostatic discharge (ESD) protection circuit such as a diode-based clamp circuit 700 to be shared across the chips. For example, a clamp circuit 700 is shown to be implemented on the Rx beamformer chip 504 for each channel to provide ESD protection functionality therein, and also coupled to the Rx front-end module 502 to provide ESD protection functionality for the corresponding channel in the Rx front-end module 502. Such a design can provide a cost-effective solution since such protection circuits are implemented on the beamformer chip in a low-cost process.

FIGS. 2 to 7 are various examples related to a receiver design. It will be understood that one or more features of the present disclosure can be implemented for a transmitter design.

For example, FIG. 8 shows a phase array transmitter (Tx) beamformer chip having RF beamforming functionality. The example Tx beamformer is shown to include eight channels. An input RF signal to the beamformer is shown to be provided to an input node (RF In) and split using a passive network 800 and distributed to each of the eight transmit channels. The RF signal to each channel is shown to be processed by a variable gain amplifier 802 and a phase shifter 804 and then further amplified by an amplifier 806.

In the example of FIG. 8, final amplification is shown to be provided on a separate chip having a highly efficient power amplifier 808. In some embodiments, similar to the receiver examples, some or all of matching circuitry for the final stage 808 can be implemented on an interposer of a corresponding packaged module using, for example, high quality factor passives. In some embodiments, such a packaged module can be implemented as a Tx packaged module.

In some embodiments, the Tx beamformer chip of FIG. 8 can be controlled using a MIPI RFFE/SPI interface 810. The beamformer chip can further include additional blocks such as temperature sensor(s) 812, bias circuit(s) 814, power detector(s) 816, etc. To store beam directions, a look up table (LUT) 818 can be utilized along with memory blocks 820 to store, for example, factory calibration settings.

Utilizing one or more features as described herein, design partitioning can be implemented to provide a much higher transmitter efficiency. Such a desirable efficiency improvement can result from a low insertion loss at the power amplifier output due to the use of high-quality factor interposer passives.

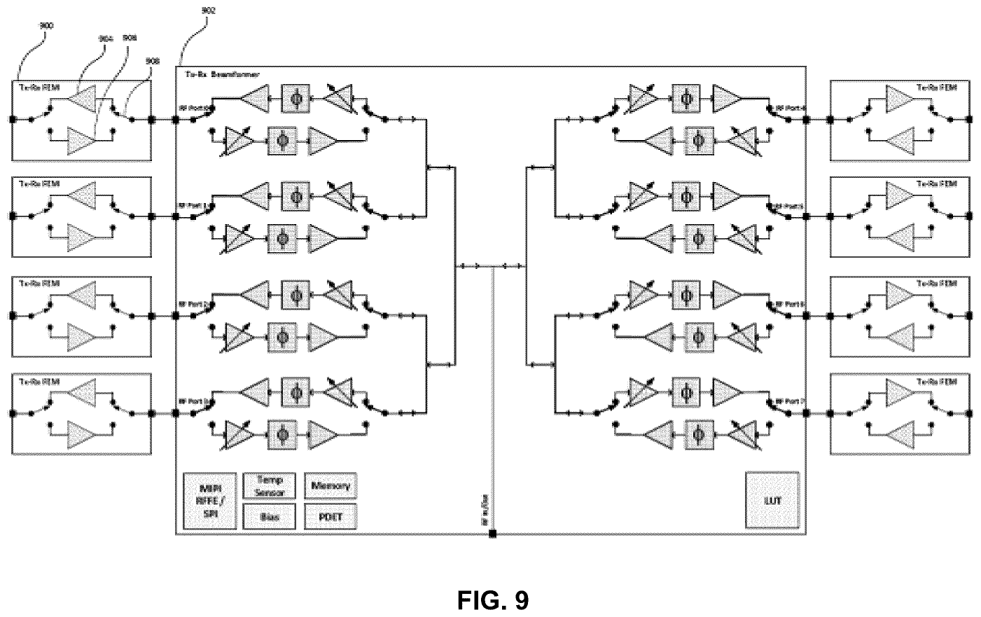

The above examples are related to a receiver or a transmitter design. However, some or all of the concepts related to such examples can be applied to a module that includes a transceiver (transmitter and receiver) as shown in FIG. 9.

In FIG. 9, 900 represents a front-end module chip that includes a power amplifier 904 and a low noise amplifier 906. In some embodiments, common input and output ports in such a front-end module can be utilized by employing a time division duplexing (TDD) switch 908. In some embodiments, the switch 908 can be removed by using separate ports for the transmit and receive portions or a diplexer to combine the signals together.

In some embodiments, the front-end module chip 900 can be interfaced to a beamformer transceiver chip 902, In the example of FIG. 9, Tx beamforming is shown to be implemented for eight channels, with each channel including a variable gain amplifier, a phase shifter, and another amplifier similar to the example channel amplification of FIG. 8. Also in the example of FIG. 9, Rx beamforming is shown to be implemented for eight channels, with each channel including a variable gain amplifier, a phase shifter, and another amplifier.

In some embodiments, the foregoing combination of Tx and Rx portions for each channel can be operated in a TDD mode utilizing an appropriate switching circuit and common input and output nodes. In some embodiments, such a switching circuit can be removed by using separate nodes for the transmit and receive portions or a diplexer to combine the signals together.

In some embodiments, passives for providing matching as described herein can be implemented on one or more interposers of a corresponding packaged module. For example, some or all of passives for the Tx portion can be implemented on an interposer similar to the example of FIG. 8, and some or all of passives for the Rx portion can be implemented on an interposer similar to the example of FIGS. 2 and 4. In some embodiments, the interposer with the passives for the Tx portion may or may not be the interposer with the passives for the Rx portion.

In some embodiments, some or all of other functional blocks described herein in reference to Rx and Tx operations can also be implemented in a packaged module having the Rx/Tx architecture of FIG. 9. For example, some or all of functional blocks associated with FIGS. 2, 6, 7 and 8 can be implemented in the Rx/Tx architecture of FIG. 9.

In some implementations, a device having one or more features described herein can be included in an RF electronic device such as a wireless platform.

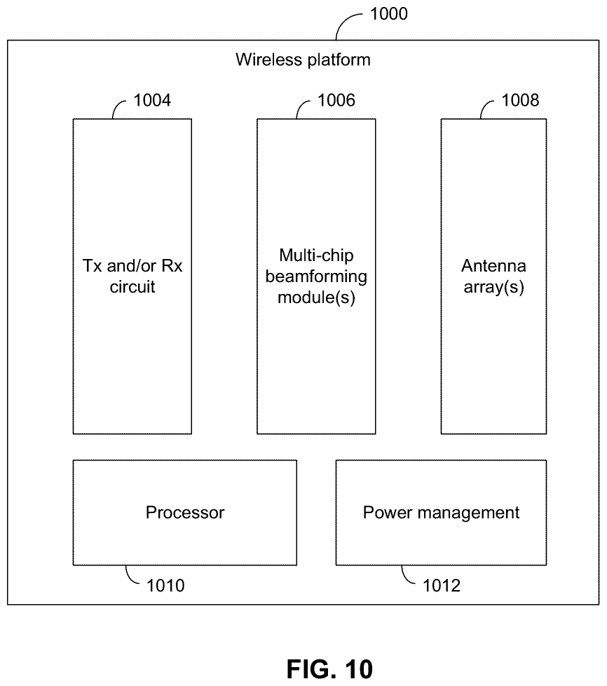

FIG. 10 depicts an example wireless platform 1000 having one or more advantageous features described herein. In the example of FIG. 10, the wireless platform 1000 can include one or more multi-chip beamforming modules (collectively indicated as 1006) having one or more features as described herein. In some embodiments, the multi-chip beamforming module(s) 1006 can include a receive-only multi-chip beamforming module configured to only provide Rx functionality. In some embodiments, the multi-chip beamforming module(s) 1006 can include a transmit-only multi-chip beamforming module configured to only provide Tx functionality. In some embodiments, the multi-chip beamforming module(s) 1006 can include a transmit-only multi-chip beamforming module configured to only provide Tx functionality, and a separate receive-only multi-chip beamforming module configured to only provide Rx functionality. In some embodiments, the multi-chip beamforming module(s) 1006 can include a single multi-chip beamforming module configured to provide both Tx and Rx functionalities.

The wireless platform 1000 of FIG. 10 is shown to further include one or more antenna arrays collectively indicated as 1008. Such antenna array(s) can be coupled to and operate with respective one or more multi-chip beamforming modules 1006.

The wireless platform 1000 of FIG. 10 is shown to further include a transmitter (Tx) circuit and/or a receiver (Rx) circuit, collectively indicated as 1004. Such Tx and/or Rx circuit(s) can be coupled to and operate with respective one or more multi-chip beamforming modules 1006.

Referring to FIG. 10, some or all operations of the Tx/Rx circuit 1004 and multi-chip beamforming module 1006 can be supported by a processor 1010 and a power management system 1012.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A packaged module comprising:
a packaging substrate including a plurality of interposer layers;
an array of receive elements implemented on a respective interposer layer, each receive element partitioned into a first block configured to provide high-performance functionality, and a second block configured to provide digitally-intensive low-performance functionality, the first and second blocks in combination configured to provide multi-channel beamforming functionality.

2. (canceled)

3. The packaged module of claim 1 wherein the first block is implemented to occupy a relatively small area on a die formed from a high-cost process technology node.

4. (canceled)

5. (canceled)

6. The packaged module of claim 3 wherein the first block includes at least a portion of a low-noise amplifier.

7. (canceled)

8. (canceled)

9. The packaged module of claim 1 wherein the second block is implemented to occupy a relatively large area on a die formed from a low-cost process technology node.

10. (canceled)

11. The packaged module of claim 9 wherein the second block includes a beamformer die.

12. The packaged module of claim 9 wherein the second block includes a low-performance component.

13. The packaged module of claim 12 wherein the low-performance component includes a portion of a low-noise amplifier.

14. (canceled)

15. The packaged module of claim 12 wherein the low-performance component includes a phase shifter.

16. The packaged module of claim 12 wherein the low-performance component includes a variable gain amplifier stage.

17. The packaged module of claim 12 wherein the low-performance component includes a temperature sensor.

18. The packaged module of claim 12 wherein the low-performance component includes a bias circuit.

19. The packaged module of claim 9 wherein the second block includes a digitally-intensive component.

20. The packaged module of claim 19 wherein the digitally-intensive component includes one or more of a control circuit, a memory circuit, and a lookup table.

21. The packaged module of claim 1 further comprising passive devices implemented on a respective interposer layer and configured to function with either or both of the first and second blocks.

22. (canceled)

23. (canceled)

24. (canceled)

25. (canceled)

26. (canceled)

27. (canceled)

28. (canceled)

29. (canceled)

30. (canceled)

31. A packaged module comprising:
a packaging substrate including a plurality of interposer layers;
an array of transmit elements implemented on a respective interposer layer, each transmit element partitioned into a first block configured to provide high-performance functionality, and a second block configured to provide digitally-intensive low-performance functionality, the first and second blocks in combination configured to provide multi-channel beamforming functionality.

32. (canceled)

33. The packaged module of claim 31 wherein the first block is implemented to occupy a relatively small area on a die formed from a high-cost process technology node.

34. (canceled)

35. (canceled)

36. The packaged module of claim 33 wherein the first block includes at least a portion of a power amplifier.

37. (canceled)

38. (canceled)

39. The packaged module of claim 31 wherein the second block is implemented to occupy a relatively large area on a die formed from a low-cost process technology node.

40. (canceled)

41. (canceled)

42. (canceled)

43. The packaged module of claim 42 wherein the low-performance component includes a portion of a power amplifier.

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. A packaged module comprising:
a packaging substrate including a plurality of interposer layers;
an array of transceiver elements implemented on a respective interposer layer, each transceiver element partitioned into a first block configured to provide high-performance functionality, and a second block configured to provide digitally-intensive low-performance functionality, the first and second blocks in combination configured to provide multi-channel beamforming functionality.

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)
